(19) United States
(12) Patent Application Publication
(10) Pub. No.: US 2025/0307702 A1
(43) Pub. Date: Oct. 2, 2025

(54) ADAPTIVE ENSEMBLES OF SAFEGUARD MODELS FOR MODERATION OF LANGUAGE MODEL APPLICATIONS

(71) Applicant: NVIDIA Corporation, Santa Clara, CA (US)

(72) Inventors: Shaona Ghosh, Campbell, CA (US); Christopher Parisien, Toronto (CA); Eileen Margaret Peters Long, San Jose, CA (US)

(21) Appl. No.: 18/769,079

(22) Filed: Jul. 10, 2024

Related U.S. Application Data
(60) Provisional application No. 63/570,541, filed on Mar. 27, 2024.

(51) Int. Cl. G06N 20/00

(52) U.S. Cl. CPC G06N 20/00

(57) ABSTRACT

Disclosed are apparatuses, systems, and techniques for adaptable provisioning of accurate and flexible assessments of safety of AI operations. The techniques include performing a probabilistic selection of a safeguard model, from an ensemble of safeguard models, to generate a safety assessment of a prompt to a language model, likelihood of the probabilistic selection being determined using historical performance of the ensemble of safeguard models.

### RELATED APPLICATIONS

This application claims the benefit of U.S. Provisional Patent Application No. 63/570,541, filed Mar. 27, 2024, entitled “Mixture of AI Safety Experts for Conversational AI Systems and Applications,” the contents of which are incorporated by reference in their entirety herein.

### TECHNICAL FIELD

At least one embodiment pertains to content generation using artificial intelligence (AI) systems. For example, at least one embodiment pertains to deployment of models that safeguard inputs and outputs of generative AI systems against unsafe and/or inappropriate use.

### BACKGROUND

Well-trained language models-such as large language models (LLMs), vision language models (VLMs), or multi-modal language models—are capable of supporting conversations in natural language, understanding speaker intents and emotions, explaining complex topics, generating new texts upon receiving suitable prompts, providing recommendations regarding topics of interest to a user, processing image, audio, and/or other data types, and/or performing other functions. These models typically undergo self-supervised training on massive amounts of text data and/or other data types, depending on the embodiment, and learn to predict next and/or missing tokens (which may correspond to sub-words, symbols, words, etc.) in a phrase/sentence, detect intent and/or sentiment of a human speaker, determine if two sentences are related or unrelated, and/or perform other basic language tasks. Following the initial training, the models often undergo instructional (prompt-based) supervised fine-tuning that causes the models to acquire more in-depth language proficiency and/or master more specialized tasks. Supervised fine-tuning includes using learning prompts (questions, hints, etc.) that are accompanied by example texts (e.g., answers, sample essays, etc.) serving as training ground truth. In reinforcement fine-tuning, a human evaluator assigns grades indicative of a degree to which the generated text resembles human-produced texts.

### BRIEF DESCRIPTION OF DRAWINGS

FIG. 1 is a block diagram of an example computer architecture capable of training and deploying adaptable systems that provide accurate and flexible assessments of safety of AI operations, according to at least one embodiment;

FIG. 2 illustrates an example computing device that supports deployment of adaptable systems that facilitate accurate and flexible assessments of safety of AI operations, according to at least one embodiment;

FIG. 3 illustrates an example data flow of a training stage that trains multiple safeguard models for use in adaptable AI safety systems, according to at least one embodiment;

FIG. 4 illustrates an example data flow of an ensemble optimization stage that optimized multiple trained safeguard models for use in domain-specific AI safety contexts, according to at least one embodiment;

FIG. 5 is a flow diagram of an example method of deployment of adaptable systems that facilitate accurate and flexible assessments of safety of AI operations, according to at least one embodiment;

FIG. 6 is a flow diagram of an example method of training safeguard models for deployment in adaptable systems that facilitate accurate and flexible assessments of safety of AI operations, according to at least one embodiment;

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 is an example data flow diagram for an advanced computing pipeline, according to at least one embodiment; and

FIG. 10 is a system diagram for an example system for training, adapting, instantiating and deploying machine learning models in an advanced computing pipeline, according to at least one embodiment;

FIG. 11A is a block diagram of an example generative language model system suitable for use in implementing at least some embodiments of the present disclosure;

FIG. 11B is a block diagram of an example embodiment in which the generative LM includes a transformer encoder-decoder, according to at least one embodiment; and

FIG. 11C is a block diagram of an example embodiment in which the generative LM 1130 includes a decoder-only transformer architecture, according to at least one embodiment.

### DETAILED DESCRIPTION

During training—especially during the self-supervised stage—AI models, including language models (LMs) (e.g., LLMs, VLMs, multi-modal language models, etc.) encounter a diverse number of texts and data related to numerous political, economic, legal, military, historical, social, and/or the like, aspects of human knowledge, which are either not filtered or are minimally filtered by the safety of its content. As a result of such a training process, LMs learn information that can be dangerous to individuals and the society at large. This can open a door for ill-meaning or unwitting users to access, at the tip of their fingers, information that can be used to facilitate unlawful or harmful objectives. For example, a user can seek advice on the ways of committing a crime, an act of terror, a suicidal act, obtain information facilitating hateful or harassing actions, and/or seek various other information that the providers of LM services may wish to restrict from free circulation.

Existing content moderation techniques include building and training safeguard models that detect presence of illicit content in user prompts to LMs and/or in responses generated by LMs and take a remedial action, such as preventing LMs from receiving prompts seeking or otherwise implicating harmful information or preventing LM responses to such prompts from being furnished to the users. A model trained to detect content of a particular kind (e.g., controlled substances) can be quite effective in looking for specific words and/or sentences that are likely to be used by the seekers of such content. Naturally, a provider of LM services may wish to prevent as many kinds of harmful information from circulation as possible. However, linguistic similarity between prompts of different kinds (e.g., between prompts for information on how to commit burglary and prompts that implicate sexualized interest in minors) is often low, and models trained to moderate one particular kind of unsafe content may not perform well on other kinds of unsafe content. The same linguistic dissimilarity makes training joint (monolithic) models-capable of detecting illicit information of multiple kinds-rather challenging, with the results that are often suboptimal. Additionally, monolithic models have limited adaptability since different customers can have different safety requirements. For example, customers can operate in different jurisdictions (e.g., states and countries), conduct business in industries having different safety standards, and/or the like. As a result, training data that is used to train a safeguard model for one customer may not work equally well for another customer having a different notion of safety and/or policies. Furthermore, AI safety is a new area where regulations are not yet fully developed and likely to change with time in addition to differing across countries and industries. Therefore, there is an inherent need for AI safety systems that can continuously learn and adapt to a changing landscape of safety requirements.

Aspects and embodiments of the present disclosure address these and other challenges related to safety of AI applications by providing for systems and techniques that facilitate deployment of adaptable ensembles of safeguard models (SGMs) capable of meeting diverse safety requirements, for application in a variety of environments, industries, jurisdictions, and/or the like. In some embodiments, training of SGM ensembles may include multiple stages. A first stage may include training individual SGMs to identify unsafe content for specific safety categories, such as hate content, sexual content, harassing content, profane content, violent content, suicide/self-harm content, threats, inappropriate content directed at minors, illegal weapons, controlled substances, crime-facilitating content, personally identifiable information, and/or any other content that may be considered unsafe or concerning in specific environments. In some embodiments, an individual SGM model may be trained to detect content implicated in multiple (e.g., two or more) safety categories. In some embodiments, more than one SGM may be trained for any given safety category, e.g., multiple models having different thresholds of unsafe content, e.g., low and high thresholds.

SGMs may be or include language models, encoder models, shallow classifiers, and/or the like, and may be trained using training data that includes examples of safe data (e.g., data with the amount or severity of unsafe content below a set threshold) and examples of unsafe data (e.g., data with the amount or severity of unsafe content above the set threshold). In some embodiments, any number of SGMs can be trained using parameter-efficient fine-tuning (PEFT) techniques, e.g., by deploying a Low-Rank Adapter (LoRA), which may be a small network having one-to-several percent of learned parameters compared with a number of parameters of an LM. After the LM is pretrained, e.g., on language understanding tasks, the parameters of the LM may be fixed (“frozen”) while parameters of the adapter network learned (modified) as part of content safety training. Such parameter-efficient systems and techniques allow the case of training and deployment, having an order or two smaller (in the number of trainable weights) than the foundational LMs.

During the second stage, individual trained SGMs are deployed in a particular use context, e.g., as part of provisioning LM services to businesses, organizations, and/or private customers. Multiple, e.g., N, SGMs may be in an ensemble in which individual models SGMⱼ are assigned weights Wⱼ (j=1 . . . . N). Initially, weights may be given equal values, e.g., Wⱼ=1 or some other starting value. Upon deployment of the ensemble, an inference input Iₖ (with index k enumerating the inputs and serving as a proxy for the duration of deployment) may be processed by the SGMs that produce corresponding outputs Oⱼ(Iₖ). For example, input Iₖ may include a user-generated prompt into a target LM, a response of the target LM to the prompt or both. (The target LM may be the same or different from the LM used to generate responses in the training stage and/or LMs that are used as part of SGMs.) The outputs Oⱼ(Iₖ) represent classifications of the input Iₖ by the corresponding SGMⱼ. The outputs Oⱼ(Iₖ) may include binary classifications (e.g., safe content or unsafe content) of the input and/or a degree of the toxicity of the input defined (as part of training of the SGMs) for a set of bins, 0, 1, 2 . . . . M. The output of the SGM ensemble then represents a set of individual SGM outputs taken together with a current set of SGM weights, {Oⱼ(Iₖ), Wⱼ}. A safety assessment of the input Iₖ, e.g., a determination whether to send the prompt to the LM, provide the LM response to the user, or to scrape the prompt and/or response may be based on an output Õ(Iₖ) selected using the set of weights {Wⱼ}. In one example, the output Õ (Iₖ) may be stochastically sampled from a suitable distribution P ({Wⱼ}), e.g., a distribution where the likelihood of selecting output Oⱼ(Iₖ) as Õ(Iₖ) is proportional to the corresponding weight, Pⱼ=ZWⱼ or an exponential function of the corresponding weight, Pⱼ=Ze^{βW}^{ⱼ}, where Z is an appropriate normalization factor and β is an empirically set parameter indicative of the breadth of the distribution (with larger values β facilitating selection of outputs of models with higher weight(s) and lower values β favoring more uniform sampling of the models.

Additionally, a ground-truth evaluator (e.g., a human expert, an organization's AI safety compliance team, an automated scoring model, or a referee LM) may perform evaluation of the input Iₖ and provide a ground truth classification O_{GT}(Iₖ) for the input. The ground truth classification O_{GT}(Iₖ) may then be compared to individual SGM outputs Oⱼ(Iₖ) and the weights of various SGMs may be adjusted based on whether the outputs match the ground truth classification. For example, the weights of the SGMs outputting the correct prediction, Oⱼ(Iₖ)=O_{GT}(Iₖ), may be increased while the weights of the SGMs outputting incorrect predictions, Oⱼ(Iₖ)≠O_{GT}(Iₖ), may be decreased according to a suitable schedule. In one embodiment, the schedule of increments and/or decrements of weights may take into account a duration of the optimization process, with higher changes of weights used after processing earlier inputs k and smaller (e.g., exponentially smaller, in some instances) changes used in later inputs k. After a number of such iterations k, the SGM ensemble may converge on a model whose predictions are most accurate for the specific domain in which the SGM ensemble is applied.

The advantages of the disclosed embodiments include adaptable systems and techniques for accurate domains-specific assessments of safety of inputs and/or outputs of the language and other AI models. An SGM ensemble is optimized during deployment of SGM models in a relevant domain while processing real inference LM inputs/outputs. As a result, an SGM ensembles deployed in different domains are optimized to different sets of weights (e.g., (e.g., an SGM ensemble optimized for use with a public search engine may end up being different from another SGM ensemble optimized for use with a banking customer service). In those instances where one or more conditions in a particular domain change, e.g., a new set of regulations is implemented, a business expands in a new direction, and/or the like, the corresponding SGM ensemble may undergo a new period of optimization to converse on a new set of weights that more closely fit the changed conditions. The disclosed embodiments implement an adaptive “no-regret” learning framework for AI safety that is guaranteed to perform (over an adaptation time horizon) at least as good as the best available expert model.

The disclosed embodiments allow an organization's AI safety compliance team to perform real-time monitoring of the deployed SGM ensemble(s) and provide periodic feedback to adjust the ensemble's performance. For example, the compliance team may choose to update the ensemble with another safeguard model in response to a new policy or a policy update, remove one or more weakly performing models, and/or optimize the ensemble's operations in any other suitable way.

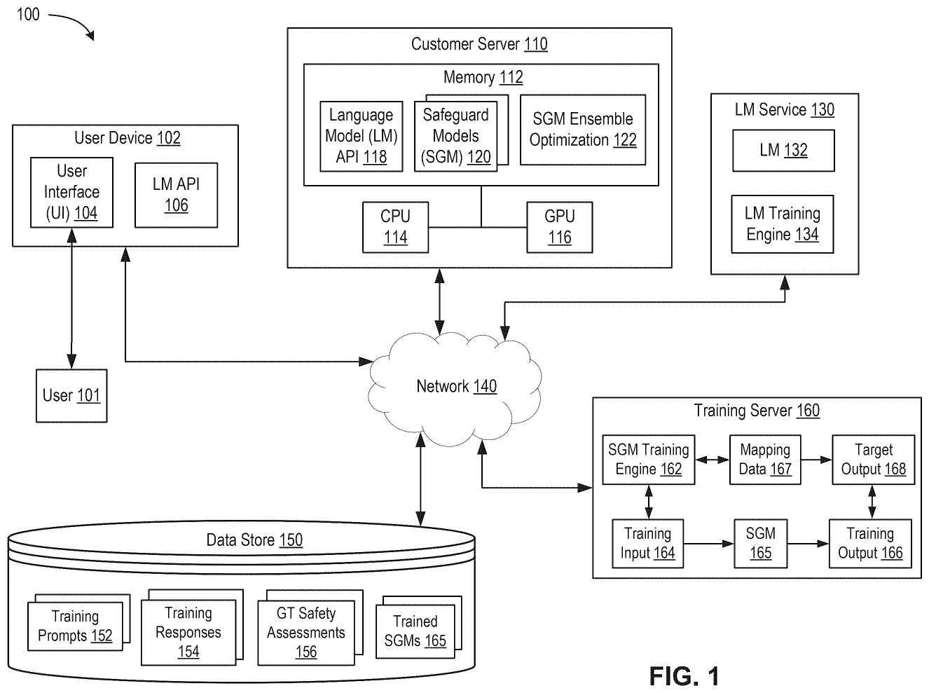

FIG. 1 is a block diagram of an example computer architecture 100 capable of training and deploying adaptable systems that provide accurate and flexible assessments of safety of AI operations, according to at least one embodiment. As depicted in FIG. 1, computer architecture 100 may include a user device 102, a customer server 110, an LM service 130, a data store 150, a training server 160, which may be connected via a network 140. Network 140 may be a public network (e.g., the Internet), a private network (e.g., a local area network (LAN), or wide area network (WAN)), a wireless network, a personal area network (PAN), a combination thereof, and/or another network type.

User device 102 may include a desktop computer, a laptop computer, a smartphone, a tablet computer, a server, a wearable device, a virtual/augmented/mixed reality headset or head-up display, a digital avatar or chatbot kiosk, an in-vehicle infotainment computing device, and/or any suitable computing device capable of performing the techniques described herein. User device 102 may be configured to communicate with user 101 via UI 104. User 101 may be an individual user (e.g., an owner of a computer, vehicle, entertainment equipment), a collective user (e.g., a business organization, an institution, a government agency, and/or the like), and/or the like. In some embodiments, prompts generated by user 101 may include a text (e.g., a sequence of one or more typed words), a speech (e.g., a sequence of one or more spoken words), or an image, and/or some combination thereof. The prompts may be generated as part of interaction of user 101 with LM service 130 hosting an LM 132 that responds to prompts from user 101.

UI 104 may include one or more devices of various modalities, e.g., a keyboard, a touchscreen, a touchpad, a writing pad, a graphical interface, a mouse, a stylus, and/or any other pointing device capable of selecting words/phrases that are displayed on a screen, and/or some other suitable device. In some embodiments, UI 104 may include an audio device, e.g., a combination of a microphone and a speaker, a video device, such as a digital camera to capture an image or a sequence of multiple images (e.g., video frames). In some embodiments, text, speech, and/or video input devices may be integrated together on a common platform, e.g., in a smartphone, tablet computer, desktop computer, and/or the like.

In some embodiments, the LM service 130 may be located on one or more computing devices/servers, e.g., on a cloud-based server. User device 102 may download LM Application Programming Interface (API) 106 from LM service 130. LM API 106 may be deployed by user device 102 to facilitate communication with the LM 132, which may be provided remotely by LM service 130.

In some embodiments, interaction of user 101 with LM 132 may be facilitated by a customer server 110 that may be a server managed by a business customer of LM service. In some embodiments, customer server 110 may be an intermediary entity that moderates services provided to user 101 by LM service 130. The business customer can be any commercial organization, non-profit organization, public organization, private organization, government organization, and or the like. In some embodiments, user 101 may be an employee, a contractor, and/or a patron of the business customer. For example, the business customer may be a public library that purchases a subscription of LM services 130 and makes these services available to library patrons.

In some embodiments, customer server 110 may include a memory 112 (e.g., one or more memory devices or units) communicatively coupled to one or more processing devices, such as one or more central processing units (CPU) 114, one or more graphics processing units (GPU) 116, one or more data processing units (DPU), one or more parallel processing units (PPUs), and/or other processing devices (e.g., field-programmable gate arrays (FPGAs), application-specific integrated circuits (ASICs), and/or the like). Memory 112 may include a read-only memory (ROM), a flash memory, a dynamic random-access memory (DRAM), such as synchronous DRAM (SDRAM), a static memory, such as static random-access memory (SRAM), and/or some other memory capable of storing digital data. Memory 112 may store LM API 118, multiple safeguard models (SGMs) 120 to moderate interactions between user 101 and LM service 130, and an SGM ensemble optimization module 122 to adapt the use of SGMs 120 to specific safety objectives of the business customer. Customer server 110 may further support any number of additional components and modules not shown explicitly in FIG. 1, such as any applications capable of generating, displaying processing, editing, and/or otherwise using text data, audio data, image data, video data, and/or the like.

In some embodiments, e.g., in the instances where user 101 is a direct subscriber of LM service 130, customer server 110 may also be operated by LM service 130. Although depicted as separate from LM service 130 in FIG. 1, in some embodiments, customer server 110 may directly host LM 132.

In some embodiments, LM 132 may be a large language model (LLM), a VLM, a multi-modal LM, etc. An LLM may be a model with at least 100K of learnable parameters. LM 132 may be supported by LM service 130. LM 132 may be trained by LM training engine 134. In some embodiments, LM 132 may be a model that has been pretrained and deployed by a separate entity. In some embodiments, LM 132 may be trained in multiple stages. Initially, LM training engine 134 may train LM 132 to capture syntax and semantics of human language, e.g., by training to predict a next, a previous, and/or a missing word in a sequence of words (e.g., one or more sentences of a human speech or text). LM 132 may be further trained using training data containing a large number of texts, such as human dialogues, newspaper texts, magazine texts, book texts, web-based texts, and/or any other texts. Since ground truth for such training is embedded in the texts themselves, LM training engine 134 may use such texts for self-supervised training of LM 132. This teaches LM 132 to carry out a conversation with a user (a human user or another computer) in a natural language in a manner that closely resembles a dialogue with a human speaker, including understanding the user's intent and responding in ways that the user expects from a conversational partner.

Following the initial self-supervised training, LM training engine 134 may implement a supervised fine-tuning or instruction fine-tuning of LM 132 to teach LM 132 more specialized language skills, including expertise in a particular field of knowledge, e.g., sports, video games, automotive technology, patient care, finance, coding, and/or the like. In some embodiments, LM training engine 134 may facilitate any, some, or all stages of training of LM 132. For example, LM training engine 134 may oversee self-supervised training, focusing on development of general language proficiency, and then passing the pretrained LM 132 to another entity for additional fine-tuning. In some instances, training engine 134 may receive a pretrained LM from another entity and perform fine-tuning of LM 132. In some instances, LM training engine 134 may perform both pretraining of LM 132 and field-specific fine-tuning of LM 132.

SGMs 120 may be trained to identify unsafe content in prompts generated by user device 102 (e.g., upon instructions from user 101) before delivering the prompts to LM 132 and/or in responses, generated by LM 132, before returning the responses to user 101. Training of SGMs 120 may be performed by training server 160, in some embodiments. Training server 160 may be operated by LM service 130, the business customer that controls customer server 110, and/or some other computing device or a network of computing devices.

In at least one embodiment, any, some, or all SGMs 120 may be implemented as deep learning neural networks having multiple levels of linear or non-linear operations. For example, any, some, or all SGMs 120 may include convolutional neural networks, recurrent neural networks, fully-connected neural networks, long short-term memory (LSTM) neural networks, neural networks with attention, e.g., transformer neural networks, and/or the like. In at least one embodiment, any, some, or all SGMs 120 may include multiple neurons, an individual neuron receiving its input from other neurons and/or from an external source and producing an output by applying an activation function to the sum of inputs modified by (trainable) weights and a bias value. In at least one embodiment, any, some, or all SGMs 120 may include multiple neurons arranged in layers, including an input layer, one or more hidden layers, and/or an output layer. Neurons from adjacent layers may be connected by weighted edges. In some embodiments, different SGMs 120 may differ by an architecture, a number of neuron layers, a number of neurons in different layers, and so on.

Any, some, or all SGMs 120 may be trained by an SGM training engine 162 hosted by training server 160, which may be (or include) a desktop computer, a laptop computer, a smartphone, a tablet computer, a server, and/or any suitable computing device capable of performing the techniques described herein. Training of SGM(s) 120 may be performed using training data stored in data store 150. Training data may include training prompts 152, training responses 154, and ground truth (GT) safety assessments 156. More specifically, SGM training engine 162 may cause execution of a specific SGM 165 being trained to process training inputs 164. Training inputs 164 may include training prompts 152, which may be actual (historical) prompts produced by users interacting with language models, prompts that are specifically generated by developers for use in training of SGMs, or some other prompts, and/or any combination thereof. Training inputs 164 may further include training responses 154, which may be historical responses to training prompts 152, responses to prompts produced by developers, synthetic responses generated by developers, and/or any combination thereof. In some embodiments, training responses 154 may be generated by a separate LM that is different from LM 132.

Some of the training inputs 164 may include training prompts 152 but not training responses 154, some of the training inputs 164 may include training responses 154 but not training prompts 152. Some of the training inputs 164 may include both training prompts 152 and training responses 154. Some of the training inputs 164 may include training prompts 152 and/or training responses 154 that do not have unsafe content (or a solicitation of unsafe content). Some of the training inputs 164 may include training prompts 152 and/or training responses 154 that have unsafe content. Different training inputs 164 with unsafe content of different levels or degrees of unsafe content, e.g., some of the training inputs 164 may include large amounts of unsafe content or content that is unquestionably dangerous. Some of the training inputs 164 may be borderline unsafe, and/or the like. Various SGMs may be trained with different notions of safety, defined by the used training data, including training inputs 164 and ground truth. Additionally, various SGMs may undergo alignment training that aligns models' performance with human values, and/or a set of values that may be specific to a particular business organization that operates customer server 110 and/or LM service 130.

During training, SGM 165 may generate training outputs 166 that represent predicted safety assessments of the corresponding training inputs 164. In some embodiments, training outputs may include binary classifications (safe content vs. unsafe content) training inputs. In some embodiments, training outputs may include multiple levels of safety concerns, e.g., 0 (safe content), 1 (borderline unsafe content), 2 (unsafe content), 3 (severely unsafe content), and so on, as a way of example and not limitation. During training, SGM training engine 162 may also generate mapping data 167 (e.g., metadata) that associates training inputs 164 with correct target outputs 168. Target outputs 168 may include ground truth assessments of training inputs 164, e.g., assessments of a degree to which training inputs 164 are unsafe. Training causes SGM 165 to identify patterns in training inputs 164 based on desired target outputs 168 and learn to accurately classify inputs as safe or unsafe.

In some embodiments, any, some, or all SGMs may include a backbone portion and an adapter portion. In some embodiments, parameters (e.g., weights and biases) of the pre-trained portion may be maintained (“frozen”) after pre-training while parameters of the adapter portion are modified during SGM training. In some embodiments, the pretrained portion may be or include an LM. The LM portion of an SGM may (but need not) be the same as LM 132 and/or an LM that is used to generate training responses 154. In some embodiments, any, some, or all SGMs may include (e.g., share) the same LM (backbone) portion. In some embodiments, any, some, or all SGMs may have LM portion(s) that are different from LM portion(s) of at least some other SGMs. The adapter portion of SGM may be small, e.g., having fewer than 10% of the number of parameters of the LM portion. In some embodiments, at least some of the parameters of the LM portion may also be learned during training.

Initially, edge parameters (e.g., weights and biases) of a trainable portion of SGM 165 being trained may be assigned some starting (e.g., random) values. For every training input 164, SGM training engine 162 may cause SGM 165 to generate training output 166. SGM training engine 162 may then compare training output 166 with the target output 168. The resulting error or mismatch, e.g., the difference between the desired target output 168 and the generated training output 166 of SGM 165, may be back-propagated through (the trainable portion of) SGM 165 and at least some parameters of SGM 165 may be changed in a direction that causes the training output 166 to evolve towards the target output 168. Such adjustments may be repeated until the output error for a given training input 164 satisfies a predetermined condition (e.g., falls below a predetermined value). Subsequently, a different training input 164 may be selected, a new training output 166 generated, and a new series of adjustments implemented, until the respective SGM 165 is trained to a target degree of accuracy or until the model(s) converges to a limit of its accuracy, determined by the model's architecture and complexity.

Training server 160 may train any number of SGMs in this (or similar) fashion using different sets of training inputs (e.g., training prompts 152, training responses 154, etc.) and target outputs 168 (e.g., ground truth safety assessments 156). For example, one set of training data may be used to train an SGM to detect queries for ways to commit a crime and a different set of training data may be used to detect queries associated with a search for political misinformation.

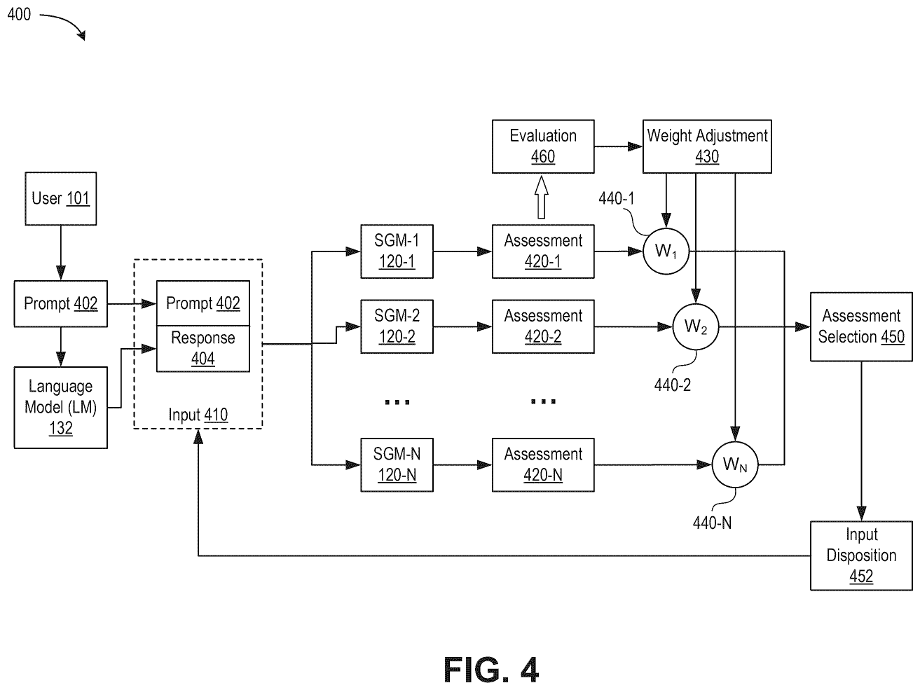

The trained SGMs 165 may be deployed on any suitable machine, e.g., customer server 110. Trained SGMs 165 may be stored in data store 150 and downloaded to customer server 110. After downloading by customer server 110, SGM ensemble optimization module 122 may combine the downloaded SGMs 120 into a domain-specific ensemble that can be optimized (adapted) for a specific domain in which customer server 110 operates. As disclosed in more detail below in conjunction with FIG. 4, such optimization (adaptation) may be performed concurrently with inference operations of the ensemble of SGMs 120.

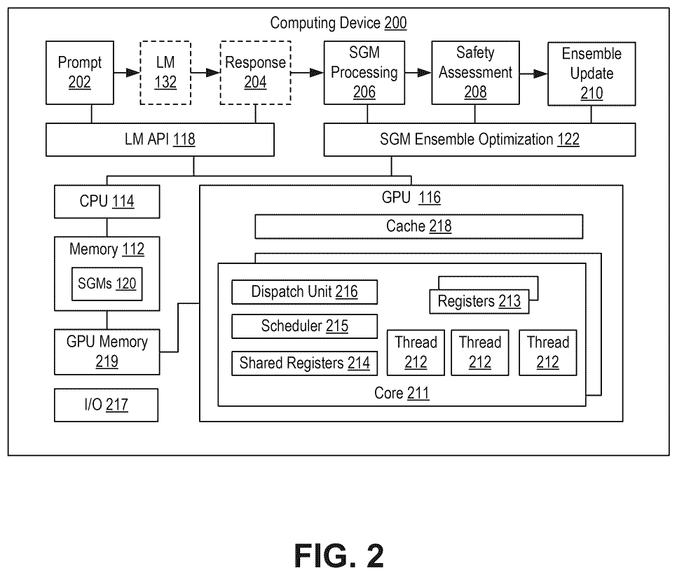

FIG. 2 illustrates an example computing device 200 that supports deployment of adaptable systems that facilitate accurate and flexible assessments of safety of AI operations, according to at least one embodiment. In at least one embodiment, computing device 200 may be a part of customer server 110 and/or a part of user device 102 (with reference to FIG. 1). In at least one embodiment, computing device 200 may deploy LM API 118 to support interactions with an LM, e.g., LM 132 maintained by LM service 130. In some embodiments, the LM may be deployed directly on computing device 200. As illustrated in FIG. 2, LM API 118 may support receiving a prompt 202 (which may be produced by any suitable user, e.g., user 101 of FIG. 1) and subjecting prompt 202 to SGM processing 206 to obtain a safety assessment 208. In some embodiments, SGM processing 206 may process prompt 202 together with a response 204 to prompt 202, e.g., as may be generated by LM 132. Safety assessment 208 may be obtained using outputs of multiple SGMs 120. In the instances where safety assessment 208 detects that no safety is at risk of being compromised, computing device 200 may forward the prompt 202 to LM 132 or forward both the prompt 202 and the received, from LM 132, response 204 to the user. In the instances where safety assessment 208 indicates that prompt 202 (and/or response 204) includes a solicitation of unsafe information (and/or furnishes such information), computing device 200 may provide a default (e.g., neutral) response to the user, which may indicate that LM 132 is unable to prompt 202, that processing of the prompt 202 would violate the terms of use of LM services, and/or generate any other suitable response. SGM ensemble optimization module 122 may evaluate accuracy of output of various SGMs 120 and perform an ensemble update 210, e.g., as disclosed in more detail below in conjunction with FIG. 4.

Operations of SGMs 120, LM API 118, SGM ensemble optimization module 122, various modules operating in conjunction with LM 132, and/or other software/firmware instantiated on computing device 200 may be executed using one or more CPUs 114, one or more GPUs 116, one or more parallel processing units (PPUs) or accelerators, such as a deep learning accelerator, data processing units (DPUs), and/or the like. In at least one embodiment, a GPU 116 includes multiple cores 211. An individual core 211 may be capable of executing multiple threads 212. Individual cores 211 may run multiple threads 212 concurrently (e.g., in parallel). In at least one embodiment, threads 212 may have access to registers 213. Registers 213 may be thread-specific registers with access to a register restricted to a respective thread. Additionally, shared registers 214 may be accessed by one or more (e.g., all) threads of a core 211. In at least one embodiment, individual cores 211 may include a scheduler 215 to distribute computational tasks and processes among different threads 212 of the core. A dispatch unit 216 may implement scheduled tasks on appropriate threads using correct private registers 213 and shared registers 214. Computing device 200 may include input/output component(s) 217 to facilitate exchange of information with one or more users or developers.

In at least one embodiment, GPU 116 may have a (high-speed) cache 218, access to which may be shared by multiple cores 211. Furthermore, computing device 200 may include a GPU memory 219 where GPU 116 may store intermediate and/or final results (outputs) of various computations performed by GPU 116. After completion of a particular task, GPU 116 (or CPU 114) may move the output to (main) memory 112. In at least one embodiment, CPU 114 may execute processes that involve serial computational tasks whereas GPU 116 may execute tasks (such as multiplication of inputs of a neural node by weights and adding biases) that are amenable to parallel processing.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine, an in-vehicle infotainment system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems for generating or presenting at least one of augmented reality content, virtual reality content, mixed reality content, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implementing one or more language models, such as large language models (LLMs), vision language models (VLMs), and/or multi-modal language models (which may process text, voice, image, and/or other data types to generate outputs in one or more formats), systems implemented at least partially using cloud computing resources, and/or other types of systems.

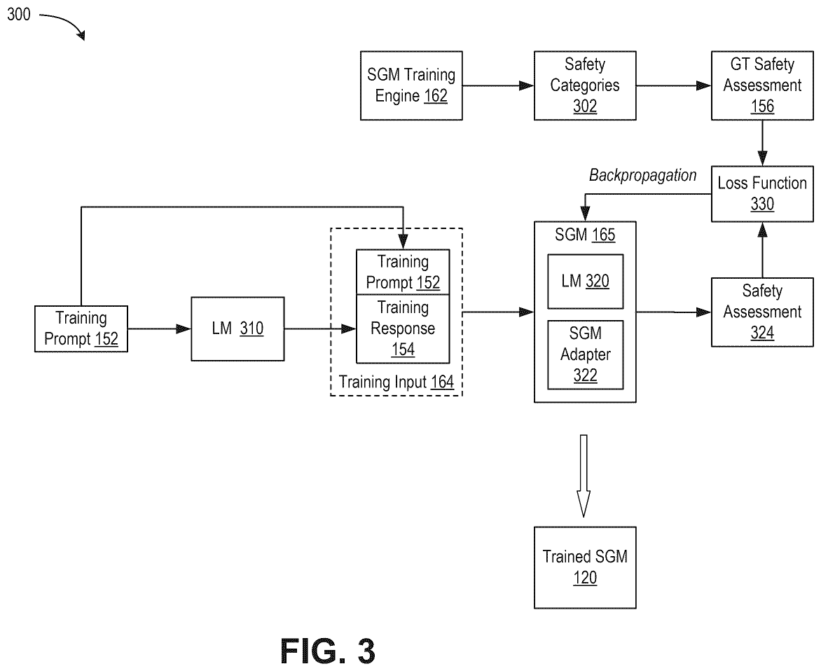

FIG. 3 illustrates an example data flow of a training stage 300 that trains multiple safeguard models for use in adaptable AI safety systems, according to at least one embodiment. Operations illustrated in FIG. 3 may be performed by SGM training engine 162. In some embodiments, SGM training engine 162 may identify one or more safety categories 302 to train a specific SGM 165 to identify unsafe content associated with such categories. As a way of example, possible safety categories may include (but need not be limited to) hate content, sexual content, harassing content, profane content, violent content, suicide/self-harm content, threats, inappropriate content directed at minors, illegal weapons, controlled substances, crime-facilitating content, personally identifiable information, political misinformation, fraud/deception, copyright/trademark infringement, plagiarism, economic harm, high-risk government decision-making, malware/viruses, biological safety, and/or any other content that may be considered unsafe or concerning in specific environments.

Operations of training stage 300 may include selecting a training prompt 152. Training prompt 152 may be, or include, past (historical) prompts produced by users interacting with language models, or prompts that are specifically generated for use in the training of SGMs. Training prompt 152 may include a user prompt or a user prompt augmented with any additional data, e.g., a system prompt, a prompt that includes retrieval-augmented data, and/or the like. In some embodiments, training prompt 152 may be a single-turn prompt, e.g., a monologue prompt with a single question/inquiry produced by a user. In some embodiments, training prompt 152 may be a multi-turn prompt, e.g., a dialogue prompt that includes two or more user question and at least one LM's response.

In some embodiments, training prompts 152 may be processed by a suitable LM 310 that generates a training response 154. In those instances where training prompt 152 includes a historical prompt and a corresponding training response 154 to that prompt is already available, processing of the training prompt 152 by LM 310 may not be performed. Training prompt 152 and/or training response 154 may be used as a training input 164 to train an individual SGM 165 to detect content implicated in the selected safety categories 302.

In some embodiments, LM 320 may be the same or different from LM 310 used to generate training responses 154 and/or an LM 132 deployed by LM service 130 (as described in conjunction with FIG. 1). In some embodiments, LM 320 may be a frozen model, e.g., a model whose parameters are fixed at pre-training and not changed during training of SGM 165. In some embodiments, SGM 165 may include an LM 320 and an SGM adapter 322. SGM adapter 322 may be a lightweight model with a smaller (in some embodiments, much smaller) number of trainable parameters, compared with LM 320. The smaller number of parameters of SGM adapter 322 makes training of SGM 165 significantly faster and less expensive, e.g., requiring less training data and fewer training epochs.

In some embodiments, SGM adapter 322 may have a low-rank architecture. More specifically, operations of a given layer of LM 320 may amount to a (frozen) h×d matrix of weights W_{h×d}. SGM adapter 322 (deployed for the same layer) may include multiple, e.g., two, matrices A_{h×r} (of dimension h×r) and B_{r×d} (of dimension r×d), where the dimension r is much smaller than h or d (or both, r<<h, d). Elements of matrices A_{h×r} and B_{r×d} may be learned during training stage 300 and be used to augment weights W_{h×d} of LM 320, e.g., according to:

$${w}_{h \times d} \to {w}_{h \times d} + {A}_{h \times r} \cdot {B}_{r \times d} .$$

Correspondingly, an input into the layer of LM 320 may be processed by two parallel branches, e.g., the frozen weights W_{h×d} of LM 320 and the low-rank matrix product A_{h×r}. B_{r×d} of SGM adapter 322, and then added together. Similar augmentation may be performed for other layers of LM 320.

In other embodiments, SGM 165 may include an encoder model, a classifier (e.g., a shallow classifier), a PEFT-based model, and/or other suitable models.

SGM 165 may generate a safety assessment 324, which may be a binary classification, such as a safe training input 164 (e.g., class “0”) or an unsafe training input 164 (e.g., class “1”). In some embodiments, the binary classification may be outputted by a final, e.g., sigmoid, classifier layer of SGM 165. In some embodiments, SGM 165 may output a probability p₀, defined within interval [0,1] that training input 164 is safe and the probability p₁=1−p₀ that training input 164 is unsafe. In some embodiments, safety assessment 324 may be an M-class classification, e.g., outputted by a softmax classifier layer of SGM 165, with any suitable number of classes defined, e.g., safe content (class “0”), weakly unsafe content (class “2”), strongly unsafe content (class “2”), and/or the like.

Safety (or lack thereof) of training input 164 may be analyzed by one or multiple human safety experts (e.g., a safety compliance team) rendering a ground truth safety assessment 156 for the training input 164. Ground truth safety assessment 156 may be compared to safety assessment 324 predicted by SGM 165 using a suitable loss function, e.g., a binary cross-entropy function. A difference between the safety assessments quantified by the loss function 330 may be used to modify SGM 165, e.g., by directly changing parameters of SGM 165 (e.g., the SGM adapter 322 portion) using various techniques of backpropagation, gradient descent, and/or the like.

Operations of training stage 300 may be performed for multiple training inputs 164. In one example non-limiting embodiment, training of SGM 165 may be performed using PEFT library with a rank r=16, context length 4096, number of epochs 3, and learning rate 1E-6. Parameters of SGM 165 may have a floating point (e.g., FP16) format with a batch size of 4. Operations of training stage 300 may be performed on multiple GPUs, e.g., four, eight, sixteen, etc. V100 GPUs with 32 GB GPU memory or some other suitable amount of memory. In one example embodiment, the learning rate may be set to 5E-6, with number of epochs 10, rank r=32, and a maximum sequence length of 4096 tokens.

After training of SGM 165, the trained SGM 120 may be deployed as part of a SGM ensemble for inference and simultaneous ensemble optimization, e.g., as disclosed in more detail below in conjunction with FIG. 4.

FIG. 4 illustrates an example data flow of an ensemble optimization stage 400 that optimized multiple trained safeguard models for use in domain-specific AI safety contexts, according to at least one embodiment. Operations of ensemble optimization stage 400 illustrated in FIG. 4 may be performed by various modules of customer server 110 of FIG. 1, e.g., SGMs 120 and SGM ensemble optimization module 122. At deployment, multiple SGMs 120-1 . . . 120-N may be selected for use by customer server 110, e.g., based on specific safety concerns and objectives of a business operating customer server 110. For example, selection of SGMs 120-n may be performed based on a catalog of trained SGMs 165 available for downloading from data store 150. Downloaded SGMs 120-n may be deployed as part of an SGM ensemble that is used for inference processing of new data (e.g., prompts and/or responses previously not encountered by SGMs 120-n during the training stage 300). Optimization of the SGM ensemble may be performed in conjunction with inference processing, e.g., as disclosed in more detail below.

As illustrated, a user 101 may produce a prompt 402. Prompt 402 may be typed, spoken, or entered in any other suitable form, e.g., as an image, an audio, or a combination of a text, image, or audio, and so on. Prompt 402 may include a user prompt and/or any additional information, e.g., instructions added by computing software, e.g., an LM API operating on the user device or customer server 110, a default prompt, a system prompt, a retrieval-augmented data, and/or the like. Prompt 402 may be included in an input 410 into the SGM ensemble. The input 410 is also referred to as input Iₜ herein, with index t enumerating the inputs since the start of the SGM ensemble deployment.

In some embodiments, prompt 402 may be processed by an LM 132 that generates a response 404 to the prompt 402, and the response 404 may be included in input 410. In some embodiments, processing by the SGM ensemble may occur before prompt 402 is provided to LM 132 and/or before response 404 is provided to user 101. In some embodiments, prompt 402 and response 404 may be processed separately by the SGM ensemble. In multi-turn (dialogue) conversations with LM 132, a separate prompt or prompt-response pair may be processed individually by the SGM ensemble. In some embodiments, input 410 may include multiple (e.g., some or all) prompt-response pairs of a dialogue conversation.

Individual deployed SGMs 120-n may process input 410 and generate corresponding individual assessments 420-n of the input's safety (or lack thereof), also denoted as outputs Oⱼ(Iₖ) herein. Since SGMs 120-n may be trained to identify unsafe content associated with various specific safety categories, the same input 410 may be assessed as unsafe by some of the SGMs 120-n and as safe by other SGMs 120-n. A suitable assessment selection 450 may be deployed to select from individual assessments 420-1 . . . 420-N, e.g., using weights 440-1 . . . 440-N assigned to the respective SGMs by weight adjustment 430.

Initially, weight adjustment 430 may assign equal weights 440-n, e.g., Wⱼ=1, or any other starting value, meaning that any one of assessments 420-n may be equally likely of being selected as a representative assessment. During the ensemble optimization stage 400, weights Wⱼ may change to favor assessments 420-n generated by those SGMs that have historically been more accurate than the SGMs that have been less accurate. Assessment selection 450 may define a suitable distribution Pⱼ({Wⱼ}) for selecting (sampling) assessment 420-n parameterized by the (current) set of weights.

In one non-limiting example embodiment, the distribution may be a parameter-free linear distribution,

$${P}_{j} = \frac{{W}_{j}}{{Σ}_{i}^{N} {W}_{i}} ,$$

in which the (normalized) probability Pⱼ is proportional to the respective weight Wⱼ.

In another non-limiting example embodiment, the distribution may be an exponential (softmax-type) distribution,

$${P}_{j} = \frac{{e}^{β {W}_{j}}}{{Σ}_{i}^{N} {e}^{β {W}_{i}}} ,$$

parameterized with an empirically set parameter β, which determines the breadth of the distribution, with smaller values β<<1 corresponding to almost uniform sampling of different assessments 420-n and larger values β>1 favoring outputs of models with higher weights Wⱼ (with the model having the maximum weight selected with certainty for very large values β>>1.)

A practically unlimited number of other distributions Pⱼ—e.g., defined by any suitable function of the weight Wⱼ—may be used for assessment selection 450. A probabilistically sampled assessment Oₛₐₘ(Iₜ) may be used for input disposition 452. For example, if the assessment Oₛₐₘ(Iₜ) indicates no adverse safety issues, prompt 402 may be forwarded to LM 132 or response 404 may be provided to user 101. In those instances where sampled assessment Oₛₐₘ(Iₜ) signals an unsafe content, prompt 402 may not be forwarded to LM 132 and/or response 404 may be prevented from reaching user 101. Instead, a neutral default response may be communicated to user 101 advising the user that prompt 402 cannot be processed, referring the user to the license agreement, asking the user to reformulate the prompts, and/or the like.

Assessments Oⱼ(Iₜ) may be provided for evaluation 460 that may include comparison of the assessments to an expert assessment, also referred to as a ground truth classification O_{GT}(Iₜ). The expert assessment may be provided by, e.g., a human expert, a team of human experts, an automated scoring model, a referee LM, and/or the like. Weight adjustment 430 may reduce (decrease) weights of those SGM(s) whose outputs were incorrect, Oₛₐₘ(Iₜ)≠O_{GT}(Iₜ), and increase weights of those SGM(s) whose outputs were accurate, Oₛₐₘ(Iₜ)=O_{GT}(Iₜ).

In some embodiments, weights may be adjusted after processing of each input Iₜ. In other embodiments, weights may be adjusted after processing and accumulating evaluation data for a certain (e.g., predetermined) horizon T of the inputs. In some embodiments, the number T may be the total number of inputs processed since deployment or evaluated since deployment, if only a subset of all output assessments undergoes evaluation 460. In some embodiments, the number T may be the number of inputs processed since the last weight adjustment.

In some embodiments, a suitable regret function can be defined to quantify the accuracy of assessments 420-n generated by various SGMs 120-n over the horizon T. For example, each correct assessment round may be assigned zero loss l=0 and each incorrect assessment may be assigned a non-zero loss, e.g., l=1 or some other value. The set of weights {Wᵢ} may be selected—at hindsight—in such a way as to minimize the expectation value of the regret function, e.g., the total loss, for the T inputs of the horizon when sampling occurs according to the distribution Pⱼ ({Wᵢ}).

In some embodiments, the regret function may be computed as the expectation value of the difference between the loss incurred in the sampled assessment and the cumulative loss associated with the most accurate—in hindsight over horizon T—SGM 120-n:

$$R = E [ {\sum }_{t = 1}^{T} l ( {O}_{s a m} ( {I}_{t} ) ) - min \{ {\sum }_{t = 1}^{T} l ( {O}_{j} ( {I}_{t} ) ) ; j \} ]$$

In some embodiments, weight adjustment 430 may be performed for some portion of inference inputs. For example, during an adaptation phase, which may include processing m inputs, weight adjustment 430 is used to identify the most accurate SGM. During a compliance phase, p additional inputs may be processed with the safety assessments performed by the identified most accurate SGM while the performance is continued to be monitored (e.g., using evaluation 460). During the new adaptation stage, m next inputs are processed, with the weights adjusted and a new most accurate SGM selected, and so on

In some embodiments, the weights may be adjusted according to the following formula,

$${W}_{j} ( t + 1 ) = {W}_{j} ( t ) exp [ - η l ( {O}_{j} ( {I}_{t} ) ) ] + {e}^{- exp [ - 1 / η ]} .$$

where η is an empirically selected parameter characterizing the speed of adaptation, e.g., η=0.26, in one example embodiment.

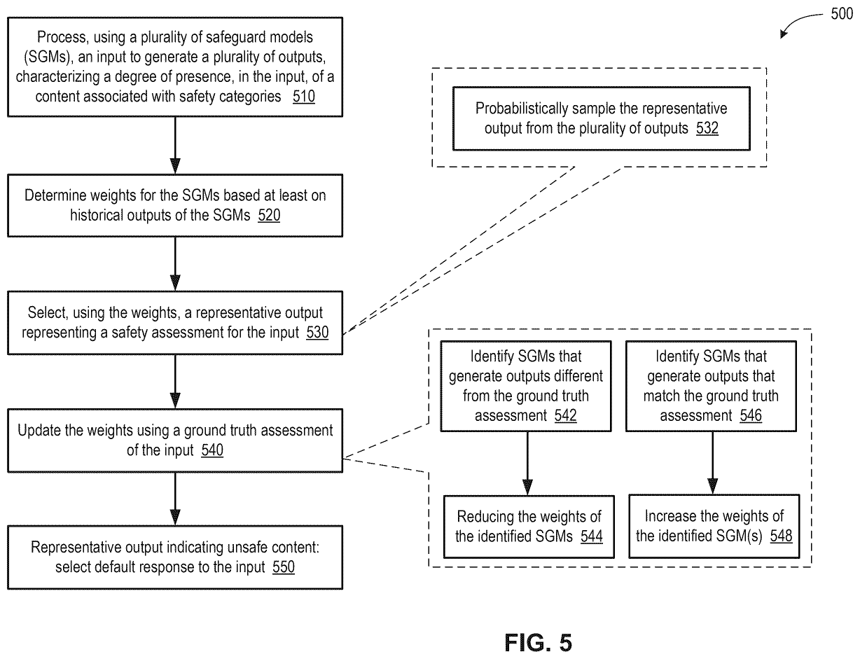

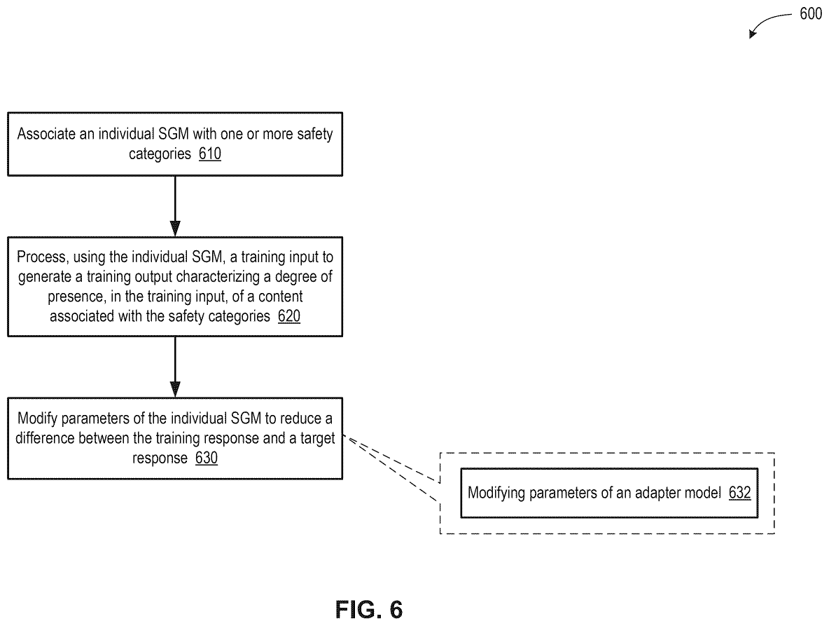

FIGS. 5 and 6 illustrate example methods 500 and 600 directed to training and deployment of adaptable AI safety systems. Methods 500 and 600 may be used in the context of provisioning conversational AI including chatbot services, AI-based search engines, database-mining services, text-based services, voice-based services, image-based services, and/or the like. Methods 500 and 600 may be used to facilitate probabilistic selection of a safeguard model, from an ensemble of safeguard models, to generate a safety assessment of a prompt to a language model, a likelihood of the probabilistic selection determined using historical performance of the ensemble of safeguard models. In at least one embodiment, methods 500 and/or 600 may be performed using processing units of computing device 200 of FIG. 2, which may be (or include) a device associated with customer server 110, training server 160, and/or other devices. In at least one embodiment, processing units performing methods 500 and/or 600 may be executing instructions stored on a non-transient computer-readable storage media. In at least one embodiment, methods 500 and/or 600 may be performed using multiple processing threads (e.g., CPU threads and/or GPU threads), with individual threads executing one or more individual functions, routines, subroutines, or operations of the methods. In at least one embodiment, processing threads implementing any of methods 500 and/or 600 may be synchronized (e.g., using semaphores, critical sections, and/or other thread synchronization mechanisms). Alternatively, processing threads implementing any of methods 500 and/or 600 may be executed asynchronously with respect to each other. Various operations of any of methods 500 and/or 600 may be performed in a different order compared with the order shown in FIGS. 5 and 6. Some operations of any of methods 500 and/or 600 may be performed concurrently with other operations. In at least one embodiment, one or more operations shown in FIGS. 5 and 6 may not always be performed.

FIG. 5 is a flow diagram of an example method 500 of deployment of adaptable systems that facilitate accurate and flexible assessments of safety of AI operations, according to at least one embodiment. At block 510, method 500 may include processing, using a plurality of safeguard models (SGMs), an input (e.g., input 410 of FIG. 4) to generate a plurality of outputs (e.g., assessments 420-n). Individual outputs of the plurality of outputs may correspond to respective SGMs of the plurality of SGMs. Individual outputs may characterize a degree of presence, in the input, of a content associated with one or more safety categories of a plurality of safety categories. In some embodiments, the input may include a prompt (e.g., prompt 402) for a language model (LM) and/or a response (e.g., response 404), generated by the LM (e.g., LM 132), to the prompt.

At block 520, method 500 may include determining a plurality of weights (e.g., weights 440-n) associated with the plurality of SGMs. The weights may be determined based at least on assigning a respective weight to individual SGMs of the plurality of SGMs. The assigning of the weights may be based at least on historical outputs of the individual SGMs. In some embodiments, multiple (e.g., some or all) weights of the plurality of weights may be initially set to an equal value.

At block 530, method 500 may include selecting, using the plurality of weights, a representative output from the plurality of outputs. The representative output may be representing a safety assessment for the input. As illustrated with block 532 of the top callout portion of FIG. 5, in some embodiments, selecting the representative output may include probabilistically sampling, according to a sampling distribution, the representative output from the plurality of outputs. In some embodiments, the sampling distribution is an increasing function of the respective weight of the plurality of weights.

At block 540, method 500 may include updating, using a ground truth assessment of the input, one or more weights of the plurality of weights. In some embodiments, the ground truth assessment may be obtained by evaluating the input using one or more human evaluators, one or more trained classifier models, a referee LM, and/or the like. In some embodiments, the one or more weights of the plurality of weights are updated by an amount that is a decreasing function of a number indicative of an order of processing of the input relative to historical inputs processed by the plurality of SGMs.

In some embodiments, updating the one or more weights may include operations illustrated with the bottom callout portion of FIG. 5. More specifically, at block 542, method 500 may include identifying one or more SGMs that generate outputs that are different from the ground truth assessment. As illustrated with block 544, the weights of such SGMs may be reduced (decreased). Similarly, at block 546, method 500 may include identifying one or more SGMs that generate outputs that match the ground truth assessment. As illustrated with block 548, the weights of such SGMs may be increased.

At block 550, method 500 may continue with selecting a default response to the input, which may advise the user that the input cannot be processed, ask the user to change the input, and/or the like. Operations of block 550 may be performed responsive to the representative output indicating presence, in the input, of the content associated with one or more safety categories of the plurality of safety categories.

In some embodiments, method 500 may include updating (e.g., periodically or at scheduled times) the plurality of SGMs by adding of one or more SGMs to the plurality of SGMs (e.g., responsive to appearance of new relevant safety categories), removing one or more SGMs from the plurality of SGMs (e.g., responsive to weak performance of the respective SGMs, e.g., incorrect safety assessments), or retraining of one or more SGMs of the plurality of SGMs.

FIG. 6 is a flow diagram of an example method 600 of training safeguard models for deployment in adaptable systems that facilitate accurate and flexible assessments of safety of AI operations, according to at least one embodiment. At block 610, method 600 may include associating an individual SGM with at least one safety category of the plurality of safety categories. In some embodiments, the individual SGM may include an LM. At block 620, method 600 may include processing, using the individual SGM, a training input (e.g., training input 164 in FIG. 3) to generate a training output (e.g., safety assessment 324) characterizing a degree of presence, in the training input, of a content associated with the at least one safety category. In some embodiments, the training input may include a training prompt (e.g., training prompt 152 in FIG. 3) to a training LM, and a training response (e.g., training response 154) generated by the training LM in response to the training prompt. In some embodiments, the training LM may be an LM that is also used in method 500. In some embodiments, the training LM may be a different LM (e.g., LM 310).

At block 630, method 600 may continue with modifying one or more parameters of the individual SGM to reduce a difference between the training response (e.g., safety assessment 156) and a target response (e.g., ground truth safety assessment 156). In some embodiments, the individual SGM may also include an adapter model. As illustrated with block 632, the callout portion of FIG. 6, in some embodiments, modifying the one or more parameters of the individual SGM may include modifying a set of parameters of the adapter model.

The systems and methods described herein may be used for a variety of purposes, by way of example and without limitation, for performing one or more operations with respect to machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., an in-vehicle infotainment system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

### Inference and Training Logic

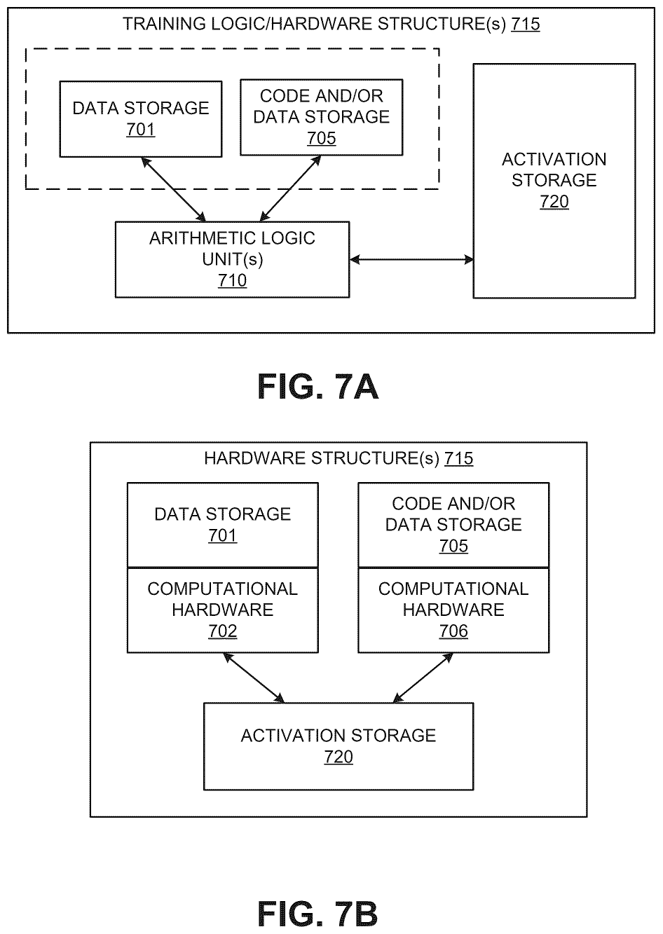

FIG. 7A illustrates inference and/or training logic 715 used to perform inferencing and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating-point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

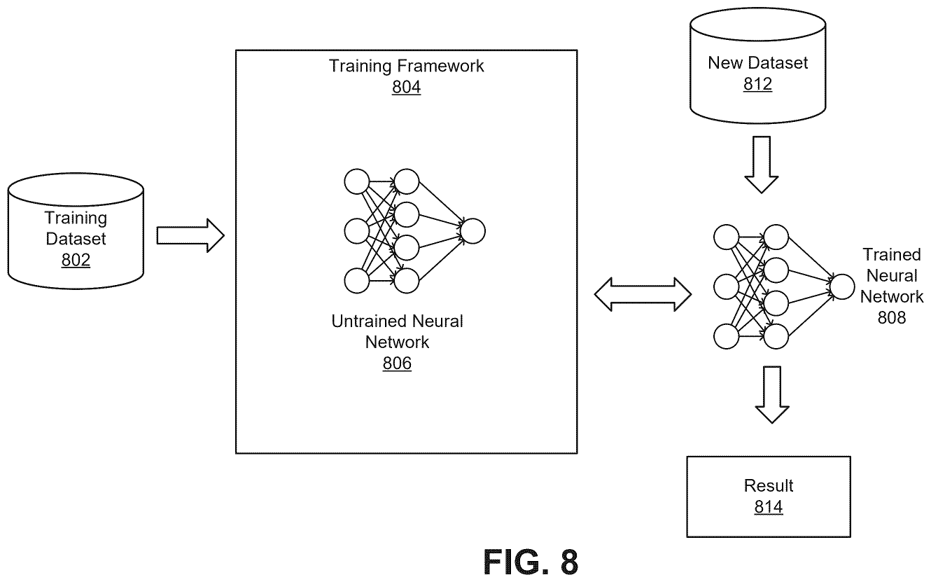

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjusting weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, whereas untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

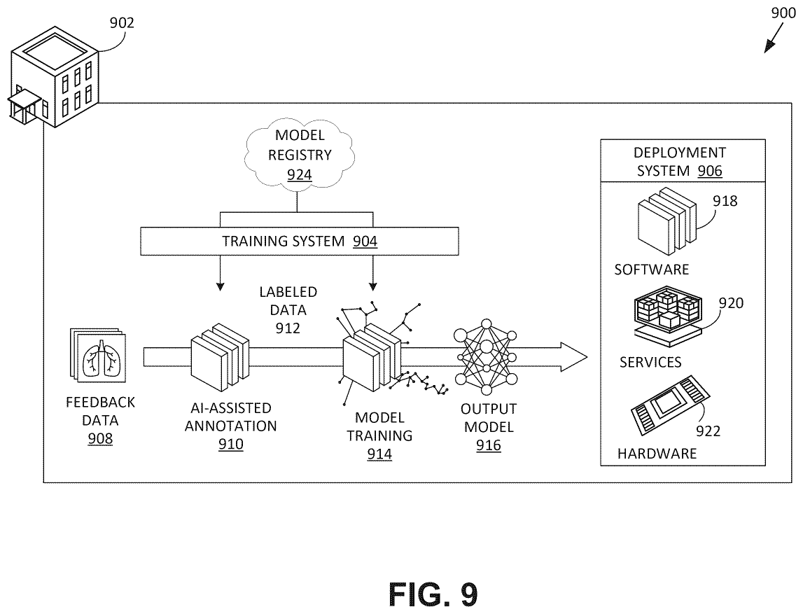

With reference to FIG. 9, FIG. 9 is an example data flow diagram for a process 900 of generating and deploying a processing and inferencing pipeline, according to at least one embodiment. In at least one embodiment, process 900 may be deployed to perform game name recognition analysis and inferencing on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some applications used in advanced processing and inferencing pipelines may use machine learning models or other AI to perform one or more processing steps. In at least one embodiment, machine learning models may be trained at facility 902 using feedback data 908 (such as imaging data) stored at facility 902 or feedback data 908 from another facility or facilities, or a combination thereof. In at least one embodiment, training system 904 may be used to provide applications, services, and/or other resources for generating working, deployable machine learning models for deployment system 906.

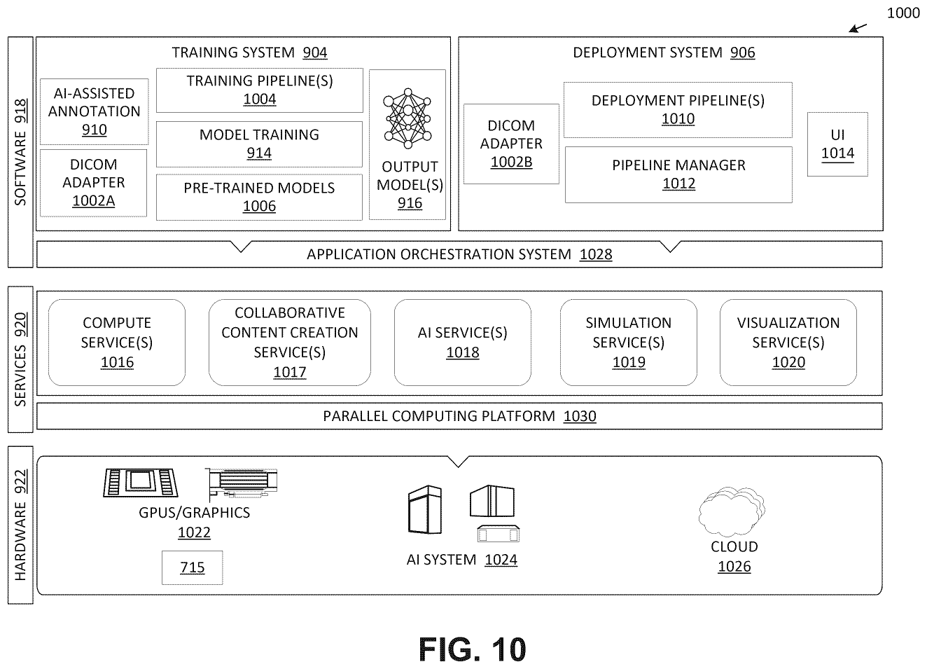

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model, or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model, e.g., via model training 914 in FIGS. 9-10. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities that are remotely located). In at least one embodiment, machine learning models may have been trained on imaging data from one location, two locations, or any number of locations. In at least one embodiment, when being trained on imaging data, which may be a form of feedback data 908, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914—e.g., AI-assisted annotations 910, labeled data 912, or a combination thereof—may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inferencing pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 916 of training system 904.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., architecture 1000 of FIG. 10). In at least one embodiment, once validated by architecture 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., architecture 1000 of FIG. 10). In at least one embodiment, completed and validated applications or containers may be stored in a container registry and associated machine learning models may be stored in model registry 924. In at least one embodiment, a requesting entity that provides an inference or image processing request may browse a container registry and/or model registry 924 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of a data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 920 may be leveraged. In at least one embodiment, services 920 may include compute services, collaborative content creation services, simulation services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel, e.g., using a parallel computing platform 1030 (FIG. 10). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 918 implementing advanced processing and inferencing pipeline may be streamlined because each application may call upon the same inference service to perform one or more inferencing tasks.

In at least one embodiment, hardware 922 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or services 920 may be optimized for GPU processing with respect to deep learning, machine learning, and/or high-performance computing, simulation, and visual computing, as non-limiting examples. In at least one embodiment, at least some of the computing environment of deployment system 906 and/or training system 904 may be executed in a datacenter or one or more supercomputers or high performance computing systems, with GPU-optimized software (e.g., hardware and software combination of NVIDIA's DGX™ system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example architecture 1000 for generating and deploying a deployment pipeline, according to at least one embodiment. In at least one embodiment, architecture 1000 may be used to implement process 900 of FIG. 9 and/or other processes including advanced processing and inferencing pipelines. In at least one embodiment, architecture 1000 may include training system 904 and deployment system 906. In at least one embodiment, training system 904 and deployment system 906 may be implemented using software 918, services 920, and/or hardware 922, as described herein.

In at least one embodiment, architecture 1000 (e.g., training system 904 and/or deployment system 906) may implemented in a cloud computing environment (e.g., using cloud 1026). In at least one embodiment, architecture 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of architecture 1000, may be restricted to a set of public internet service providers (ISPs) that have been vetted or authorized for interaction.

In at least one embodiment, various components of architecture 1000 may communicate between and among one another using any of a variety of different network types, including but not limited to local area networks (LANs) and/or wide area networks (WANs) via wired and/or wireless communication protocols. In at least one embodiment, communication between facilities and components of architecture 1000 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004, similar to a first example described with respect to FIG. 9, may be used for a first machine learning model, training pipeline 1004, similar to a second example described with respect to FIG. 9, may be used for a second machine learning model, and training pipeline 1004, similar to a third example described with respect to FIG. 9, may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904, and may be implemented by deployment system 906.

In at least one embodiment, output model(s) 916 and/or pre-trained model(s) 1006 may include any types of machine learning models depending on embodiment. In at least one embodiment, and without limitation, machine learning models used by architecture 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of, AI-assisted annotation included in training pipelines 1004. In at least one embodiment, architecture 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 902. In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types), including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface (UI) 1014 (e.g., a graphical user interface, a web interface, etc.) that may be used to select applications for inclusion in deployment pipeline(s) 1010, arrange applications, modify or change applications or parameters or constructs thereof, use and intera with deployment pipeline(s) 1010 during set-up and/or deployment, and/or to otherwise interact with deployment system 906. In at least one embodiment, although not illustrated with respect to training system 904, UI 1014 (or a different user interface) may be used for selecting models for use in deployment system 906, for selecting models for training, or retraining, in training system 904, and/or for otherwise interacting with training system 904. In at least one embodiment, training system 904 and deployment system 906 may include DICOM adapters 1002A and 1002B.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of applications or containers. In at least one embodiment, because one or more of applications or containers in deployment pipeline(s) 1010 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 920 leveraged and shared by applications or containers in deployment system 906 may include compute services 1016, collaborative content creation services 1017, AI services 1018, simulation services 1019, visualization services 1020, and/or other service types. In at least one embodiment, applications may call (e.g., execute) one or more of services 920 to perform processing operations for an application. In at least one embodiment, compute services 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA®) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inferencing services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as CNNs) for segmentation, reconstruction, object detection, feature detection, classification, and/or other inferencing tasks. In at least one embodiment, applications of deployment pipeline(s) 1010 may use one or more of output models 916 from training system 904 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inferencing tasks of AI services 1018.

In at least one embodiment, shared storage may be mounted to AI services 1018 within architecture 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure appropriate machine learning model is loaded into a cache (e.g., shared storage), and/or a copy of a model may be saved to a cache. In at least one embodiment, the scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inferencing on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing or other light transport simulation techniques, may be implemented by visualization services 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA®) and/or QUADRO® GPUs) may include any number of GPUs that may be used for executing processing tasks of compute services 1016, collaborative content creation services 1017, AI services 1018, simulation services 1019, visualization services 1020, other services, and/or any of features or functionality of software 918. For example, with respect to AI services 1018, GPUs 1022 may be used to perform pre-processing on imaging data (or other data types used by machine learning models), post-processing on outputs of machine learning models, and/or to perform inferencing (e.g., to execute machine learning models). In at least one embodiment, cloud 1026, AI system 1024, and/or other components of architecture 1000 may use GPUs 1022. In at least one embodiment, cloud 1026 may include a GPU-optimized platform for deep learning tasks. In at least one embodiment, AI system 1024 may use GPUs, and cloud 1026—or at least a portion tasked with deep learning or inferencing—may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inferencing, deep learning, machine learning, and/or other artificial intelligence tasks. In at least one embodiment, AI system 1024 (e.g., NVIDIA's DGX™) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of architecture 1000.

In at least one embodiment, cloud 1026 may include a GPU-accelerated infrastructure (e.g., NVIDIA's NGC™) that may provide a GPU-optimized platform for executing processing tasks of architecture 1000. In at least one embodiment, cloud 1026 may include an AI system(s) 1024 for performing one or more of AI-based tasks of architecture 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may be tasked with executing at least some of services 920 of architecture 1000, including compute services 1016, AI services 1018, and/or visualization services 1020, as described herein. In at least one embodiment, cloud 1026 may perform small and large batch inference (e.g., executing NVIDIA's TensorRT™), provide an accelerated parallel computing API and platform 1030 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for architecture 1000.

In at least one embodiment, in an effort to preserve patient confidentiality (e.g., where patient data or records are to be used off-premises), cloud 1026 may include a registry, such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

### Example Language Models

In at least some embodiments, language models, such as large language models (LLMs) and/or other types of generative artificial intelligence (AI) may be implemented. These models may be capable of understanding, summarizing, translating, and/or otherwise generating text (e.g., natural language text, code, etc.), images, video, computer aided design (CAD) assets, omniverse and/or metaverse file information (e.g., in USD format), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/etc. may be implemented for summarizing textual data, analyzing and extracting insights from data (e.g., textual, image, video, etc.), and generating new text/image/video/etc. in user-specified styles, tones, or formats. The LLMs of the present disclosure may be used exclusively for text processing, in embodiments, whereas in other embodiments, multimodal LLMs may be implemented to accept, understand, and/or generate text along with other types of content like images, audio, and/or video. For example, vision language models (VLMs), or more generally multimodal language models, may be implemented to accept image, video, audio, textual, 3D design (e.g., CAD), and/or other inputs data types and/or to generate or output image, video, audio, textual, 3D design, and/or other output data types.

Various types of LLM/VLM/etc. architectures may be implemented in various embodiments. For example, different architectures may be implemented that use different techniques for understanding and generating outputs-such as text, audio, video, image, etc. In some embodiments, LLM architectures such as recurrent neural networks (RNNs) or long short-term memory networks (LSTMs) may be used, while in other embodiments transformer architectures—such as those that rely on self-attention mechanisms—may be used to understand and recognize relationships between words or tokens. The language models of the present disclosure may include encoder and/or decoder block(s). For example, discriminative or encoder-only LLMs like BERT (Bidirectional Encoder Representations from Transformers) may be implemented for tasks that involve language comprehension such as classification, sentiment analysis, question answering, and named entity recognition. As another example, generative or decoder-only LLMs like GPT (Generative Pretrained Transformer) may be implemented for tasks that involve language and content generation such as text completion, story generation, and dialogue generation. LLMs that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the model(s).

In various embodiments, the LLMs/VLMs/etc. may be trained using unsupervised learning, in which an LLM learns patterns from large amounts of unlabeled text/audio/video/image/etc. data. Due to the extensive training, in embodiments, the models may not require task-specific or domain-specific training. LLMs that have undergone extensive pre-training on vast amounts of unlabeled text data may be referred to as foundation models and may be adept at a variety of tasks like question-answering, summarization, filling in missing information, and translation. Some LLMs may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/etc. of the present disclosure may be implemented using various model alignment techniques. For example, in some embodiments, guardrails may be implemented to identify improper or undesired inputs (e.g., prompts) and/or outputs of the models. In some non-limiting embodiments, the guardrails implemented may be similar to those described in U.S. Pat. App. No. 18,304,341, filed on Apr. 20, 2023, the contents of which are hereby incorporated by reference in their entirety. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/embodiment. As a result, the LLMs/VLMs/etc. of the present disclosure may be less likely to output language/text/audio/etc. that may be offensive, vulgar, improper, unsafe, out of domain, and/or otherwise undesired for the particular application/embodiment.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

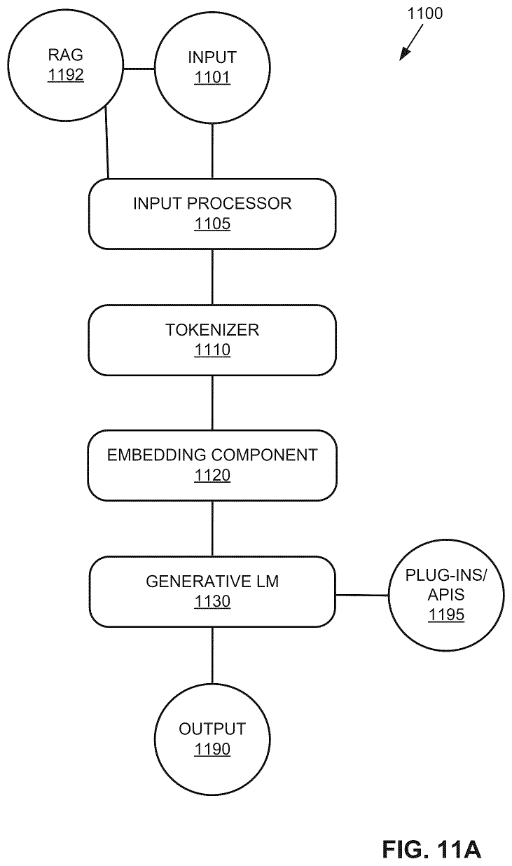

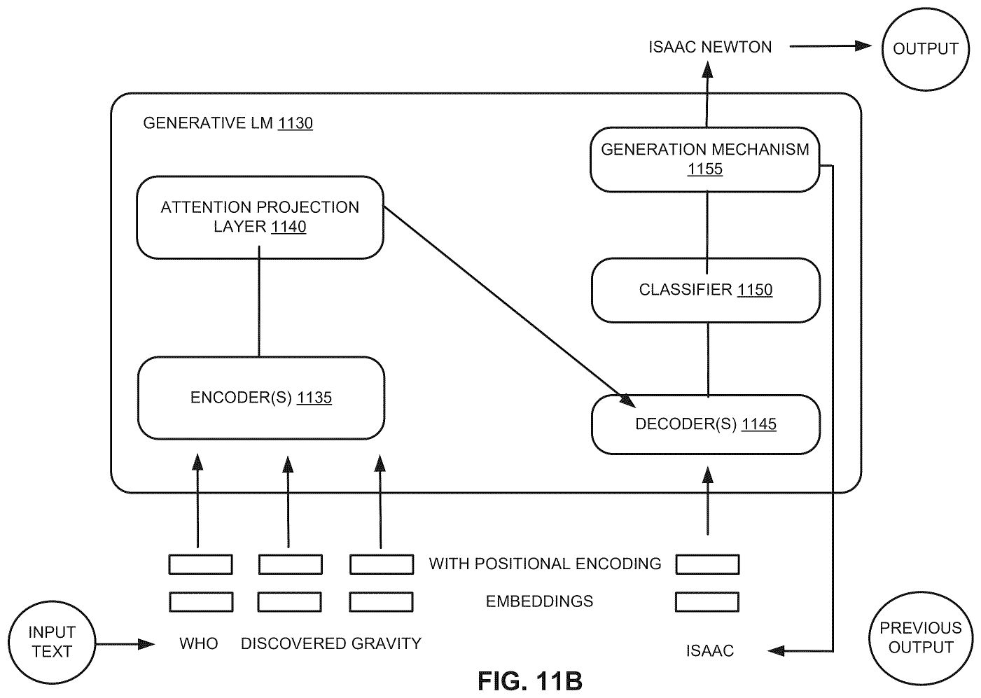

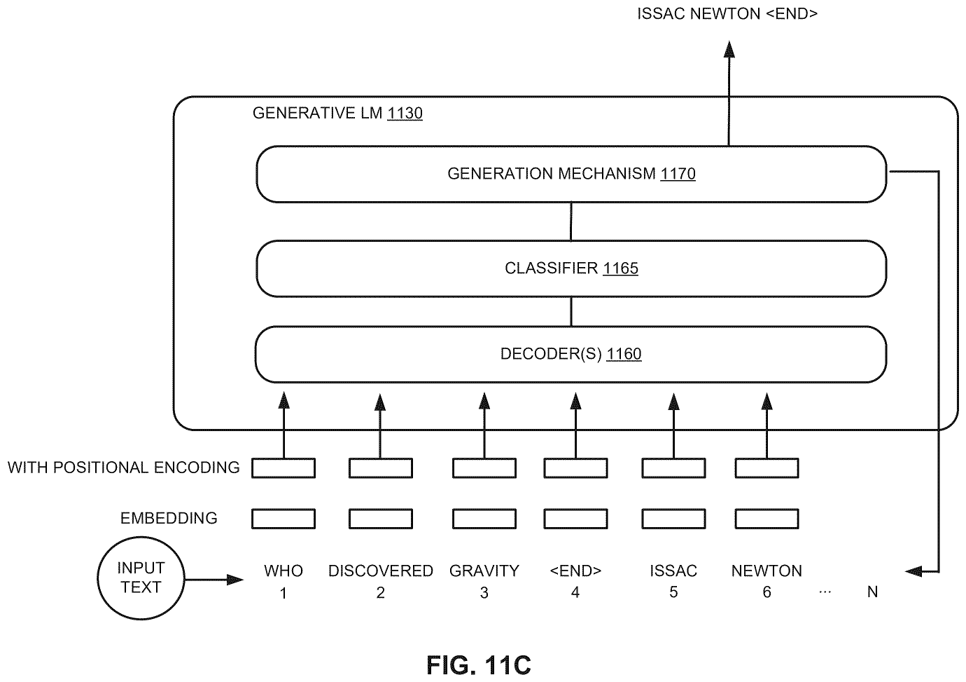

FIG. 11A is a block diagram of an example generative language model system 1100 suitable for use in implementing at least some embodiments of the present disclosure. In the example illustrated in FIG. 11A, the generative language model system 1100 includes a retrieval augmented generation (RAG) component 1192, an input processor 1105, a tokenizer 1110, an embedding component 1120, plug-ins/APIs 1195, and a generative language model (LM) 1130 (which may include an LLM, a VLM, a multi-modal LM, etc.).

At a high level, the input processor 1105 may receive an input 1101 comprising text and/or other types of input data (e.g., audio data, video data, image data, sensor data (e.g., LiDAR, RADAR, ultrasonic, etc.), 3D design data, CAD data, universal scene descriptor (USD) data, etc.), depending on the architecture of the generative LM 1130. In some embodiments, the input 1101 includes plain text in the form of one or more sentences, paragraphs, and/or documents. Additionally or alternatively, the input 1101 may include numerical sequences, precomputed embeddings (e.g., word or sentence embeddings), and/or structured data (e.g., in tabular formats, JSON, or XML). In some embodiments in which the generative LM 1130 is capable of processing multimodal inputs, the input 1101 may combine text with image data, audio data, and/or other types of input data, such as but not limited to those described herein. Taking raw input text as an example, the input processor 1105 may prepare raw input text in various ways. For example, the input processor 1105 may perform various types of text cleaning to remove noise (e.g., special characters, punctuation, HTML tags, stopwords) from relevant textual content. In an example involving stopwords (common words that tend to carry little semantic meaning), the input processor 1105 may remove stopwords to reduce noise and focus the generative LM 1130 on more meaningful content. The input processor 1105 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1192 may be used to retrieve additional information to be used as part of the input 1101 or prompt. For example, in some embodiments, the input 1101 may be generated using the query or input to the model (e.g., a question, a request, etc.) in addition to data retrieved using the RAG component 1192. In some embodiments, the input processor 1105 may analyze the input 1101 and communicate with the RAG component 1192 (or the RAG component 1192 may be part of the input processor 1105, in embodiments) in order to identify relevant text and/or other data to provide to the generative LM 1130 as additional context or sources of information from which to identify the response, answer, or output 1190, generally. For example, where the input indicates that the user is interested in a desired tire pressure for a particular make and model of vehicle, the RAG component 1192 may retrieve-using a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1192 may retrieve a prior stored conversation history—or at least a summary thereof—and include the prior conversation history along with the current ask/request as part of the input 1101 to the generative LM 1130.

The tokenizer 1110 may segment the (e.g., processed) text into smaller units (tokens) for subsequent analysis and processing. The tokens may represent individual words, subwords, characters, etc., depending on the embodiment. Word-based tokenization divides the text into individual words, treating each word as a separate token. Subword tokenization breaks down words into smaller meaningful units (e.g., prefixes, suffixes, stems), enabling the generative LM 1130 to understand morphological variations and handle out-of-vocabulary words more effectively. Character-based tokenization represents each character as a separate token, enabling the generative LM 1130 to process text at a fine-grained level. The choice of tokenization strategy may depend on factors such as the language being processed, the task at hand, and/or characteristics of the training dataset. As such, the tokenizer 1110 may convert the (e.g., processed) text into a structured format according to tokenization schema being implemented in the particular embodiment.

The embedding component 1120 may use any known embedding technique to transform discrete tokens into (e.g., dense, continuous vector) representations of semantic meaning. For example, the embedding component 1120 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some embodiments in which the input 1101 includes image data, the input processor 1101 may resize the image data to a standard size compatible with format of a corresponding input channel and/or may normalize pixel values to a common range (e.g., 0 to 1) to ensure a consistent representation, and the embedding component 1120 may encode the image data using any known technique (e.g., using one or more convolutional neural networks (CNNs) to extract visual features). In some embodiments in which the input 1101 includes audio data, the input processor 1101 may resample an audio file to a consistent sampling rate for uniform processing, and the embedding component 1120 may use any known technique to extract and encode audio features-such as in the form of a spectrogram (e.g., a mel-spectrogram). In some embodiments in which the input 1101 includes video data, the input processor 1101 may extract frames or apply resizing to extracted frames, and the embedding component 1120 may extract features such as optical flow embeddings or video embeddings and/or may encode temporal information or sequences of frames. In some embodiments in which the input 1101 includes multimodal data, the embedding component 1120 may fuse representations of the different types of data (e.g., text, image, audio) using techniques like early fusion (concatenation), late fusion (sequential processing), attention-based fusion, etc.

The generative LM 1130 and/or other components of the generative LLM system 1100 may use different types of neural network architectures depending on the embodiment. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the embodiment and architecture, the embedding component 1120 may apply an encoded representation of the input 1101 to the generative LM 1130, and the generative LM 1130 may process the encoded representation of the input 1101 to generate an output 1190, which may include responsive text and/or other types of data.

As described herein, in some embodiments, the generative LM 1130 may be configured to access or use—or capable of accessing or using—plug-ins/APIs 1195 (which may include one or more plug-ins, application programming interfaces (APIs), databases, data stores, repositories, etc.). For example, for certain tasks or operations that the generative LM 1130 is not ideally suited for, the model may have instructions (e.g., as a result of training, and/or based on instructions in a given prompt, such as those retrieved using the RAG component 1192) to access one or more plug-ins/APIs 1195 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1195 to the plug-in/API 1195, the plug-in/API 1195 may process the information and return an answer to the generative LM 1130, and the generative LM 1130 may use the response to generate the output 1190. This process may be repeated—e.g., recursively—for any number of iterations and using any number of plug-ins/APIs 1195 until an output 1190 that addresses each ask/question/request/process/operation/etc from the input 1101 can be generated. As such, the model(s) may not only rely on its own knowledge from training on a large dataset(s) and/or from data retrieved using the RAG component 1192, but also on the expertise or optimized nature of one or more external resources-such as the plug-ins/APIs 1195.

FIG. 11B is a block diagram of an example embodiment in which the generative LM 1130 includes a transformer encoder-decoder, according to at least one embodiment. For example, assume input text such as “Who discovered gravity” is tokenized (e.g., by the tokenizer 1110 of FIG. 11A) into tokens such as words, and each token is encoded (e.g., by the embedding component 1120 of FIG. 911A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1135 of the generative LM 1130.

In an example embodiment, the encoder(s) 1135 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1140 may convert the context vector into attention vectors (keys and values) for the decoder(s) 1145.

In an example embodiment, the decoder(s) 1145 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1135, in an example transformer architecture, each token (e.g., word) flows through a separate path in the decoder(s) 1145. During a first pass, the decoder(s) 1145, a classifier 1150, and a generation mechanism 1155 may generate a first token, and the generation mechanism 1155 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1145 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example embodiment, the encoder-decoder attention layer operates similarly to the (e.g., multi-headed) self-attention in the encoder(s) 1135, except that it creates its queries from the layer below it and takes the keys and values (e.g., matrix) from the output of the encoder(s) 1135.

As such, the decoder(s) 1145 may output some decoded (e.g., vector) representation of the input being applied during a particular pass. The classifier 1150 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1155 may select or sample a word or token based on a corresponding predicted probability (e.g., select the word with the highest predicted probability) and append it to the output from a previous pass, generating each word or token sequentially. The generation mechanism 1155 may repeat the process, triggering successive decoder inputs and corresponding predictions until selecting or sampling a symbol or token that represents the end of the response, at which point, the generation mechanism 1155 may output the generated response.

FIG. 11C is a block diagram of an example embodiment in which the generative LM 1130 includes a decoder-only transformer architecture, according to at least one embodiment. For example, the decoder(s) 1160 of FIG. 11C may operate similarly as the decoder(s) 1145 of FIG. 11B except each of the decoder(s) 1160 of FIG. 11C omits the encoder-decoder self-attention layer (since there is no encoder in this embodiment). As such, the decoder(s) 1160 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1160. As with the decoder(s) 1145 of FIG. 11B, each token (e.g., word) may flow through a separate path in the decoder(s) 1160, and the decoder(s) 1160, a classifier 1165, and a generation mechanism 1170 may use auto-regression to sequentially generate one token at a time until predicting a symbol or token that represents the end of the response. The classifier 1165 and the generation mechanism 1170 may operate similarly as the classifier 1150 and the generation mechanism 1155 of FIG. 11B, with the generation mechanism 1170 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
processing, using a plurality of safeguard models (SGMs), an input to generate a plurality of outputs, individual outputs of the plurality of outputs corresponding to respective SGMs of the plurality of SGMs and characterizing a degree of presence, in the input, of a content associated with one or more safety categories of a plurality of safety categories;
determining a plurality of weights associated with the plurality of SGMs based at least on assigning a respective weight to individual SGMs of the plurality of SGMs based at least on historical outputs of the individual SGMs;
selecting, using the plurality of weights, a representative output from the plurality of outputs, the representative output representing a safety assessment for the input; and
updating, using a ground truth assessment of the input, one or more weights of the plurality of weights.

2. The method of claim 1, wherein the input comprises at least one of:
a prompt for a language model (LM), or
a response, generated by the LM, to the prompt.

3. The method of claim 1, wherein the selecting the representative output comprises:
probabilistically sampling, according to a sampling distribution, the representative output from the plurality of outputs, wherein the sampling distribution is an increasing function of the respective weight of the plurality of weights.

4. The method of claim 1, wherein the updating the one or more weights comprises:
identifying one or more SGMs of the plurality of SGMs, wherein the one or more SGMs generate outputs different from the ground truth assessment; and
reducing the weights of the one or more identified SGMs.

5. The method of claim 1, wherein the updating the one or more weights comprises:
identifying one or more SGMs of the plurality of SGMs, wherein the one or more SGMs generate outputs that match the ground truth assessment; and
increasing the weights of the one or more identified SGMs.

6. The method of claim 1, wherein multiple weights of the plurality of weights are initially set to an equal value.

7. The method of claim 1, wherein the one or more weights of the plurality of weights are updated by an amount that is a decreasing function of a number indicative of an order of processing of the input relative to historical inputs processed by the plurality of SGMs.

8. The method of claim 1, wherein the ground truth assessment is obtained by evaluating the input using at least one of:
one or more human evaluators,
a trained classifier model, or
a referee LM.

9. The method of claim 1, further comprising:
updating the plurality of SGMs with one or more of:
addition of one or more SGMs to the plurality of SGMs,
removal of one or more SGMs from the plurality of SGMs, or
retraining of one or more SGMs of the plurality of SGMs.

10. The method of claim 1, further comprising:
responsive to the representative output indicating presence, in the input, of the content associated with one or more safety categories of the plurality of safety categories, selecting a default response to the input.

11. The method of claim 1, wherein an individual SGM of the plurality of SGMs is trained using operations comprising:
associating the individual SGM with at least one safety category of the plurality of safety categories, wherein the individual SGM comprises an LM;
processing, using the individual SGM, a training input to generate a training output characterizing a degree of presence, in the training input, of a content associated with the at least one safety category, wherein the training input comprises at least one of:
a training prompt to a training LM, wherein the training LM comprises at least one of the LM or a second LM,
a training response, generated by the training LM, to the training prompt;
modifying one or more parameters of the individual SGM to reduce a difference between the training response and a target response.

12. The method of claim 11, wherein the individual SGM further comprises an adapter model, and wherein the modifying the one or more parameters of the individual SGM comprises:
modifying a set of parameters of the adapter model.

13. The method of claim 1, wherein the plurality of safety categories comprises:
a hate content,
a sexualized content, a
harassing content,
a profane content,
a violent content,
a self-harm content,
a threat content,
a minor-directed content,
an illegal weapon content,
a controlled substance content,
a crime-facilitating content,
a personally identifiable content,
a misinformation content,
a fraud content,
a copyright-infringing content,
a trademark-infringing content,
a plagiarism content,
an economic harm content,
a biological harm content, or
a malware content.

14. A system comprising:
one or more processors to:
process, using a plurality of safeguard models (SGMs), an input to generate a plurality of outputs, individual outputs of the plurality of outputs corresponding to respective SGMs of the plurality of SGMs and characterizing a degree of presence, in the input, of a content associated with one or more safety categories of a plurality of safety categories;
determine a plurality of weights associated with the plurality of SGMs based at least on assigning a respective weight to individual SGMs of the plurality of SGMs based at least on historical outputs of the individual SGMs;
select, using the plurality of weights, a representative output from the plurality of outputs, the representative output representing a safety assessment for the input; and
update, using a ground truth assessment of the input, one or more weights of the plurality of weights.

15. The system of claim 14, wherein to select the representative output, the one or more processors are to:
probabilistically sample, according to a sampling distribution, the representative output from the plurality of outputs, wherein the sampling distribution is an increasing function of the respective weight of the plurality of weights.

16. The system of claim 14, wherein to update the one or more weights, the one or more processors are to:
identify one or more SGMs of the plurality of SGMs, wherein the one or more SGMs generate outputs different from the ground truth assessment; and
reducing the weights of the one or more identified SGMs.

17. The system of claim 14, wherein to update the one or more weights, the one or more processors are to:
identify one or more SGMs of the plurality of SGMs, wherein the one or more SGMs generate outputs that match the ground truth assessment; and
increase the weights of the one or more identified SGMs.

18. The system of claim 14, wherein the one or more weights of the plurality of weights are updated by an amount that is a decreasing function of a number indicative of an order of processing of the input relative to historical inputs processed by the plurality of SGMs,

19. A system comprising one or more processors to perform a probabilistic selection of a safeguard model, from an ensemble of safeguard models, to generate a safety assessment of a prompt to a language model, a likelihood of the probabilistic selection being determined using historical performance of the ensemble of safeguard models.

20. The system of claim 19, wherein the system is comprised in at least one of:
an in-vehicle infotainment system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system for generating or presenting at least one of virtual reality content, mixed reality content, or augmented reality content;
a system implemented using a robot;
a system for performing one or more conversational AI operations;
a system implementing one or more language models;
a system implementing one or more large language models (LLMs);
a system implementing one or more vision language models (VLMs);
a system implementing one or more multi-modal language models;
a system for performing one or more generative AI operations;
a system for generating synthetic data;
a system incorporating one or more virtual machines (VMs);
a system implemented at least partially in a data center, or
a system implemented at least partially using cloud computing resources.
